(19) United States
(12) Patent Application Publication
(10) Pub. No.: US 2008/0160332 A1
(43) Pub. Date: Jul. 3, 2008

(54) METHOD OF APPLYING BRAZE FILLER METAL POWDERS TO SUBSTRATES FOR SURFACE CLEANING AND PROTECTION

(75) Inventors: Manish DIGHE, West Chester, OH (US); Jeffrey Reid THYSSEN, Salem, MA (US)

Correspondence Address: MCNEES WALLACE & NURICK LLC, 100 PINE STREET, P.O. BOX 1166, HARRISBURG, PA, 17108-1166, US

(73) Assignee: GENERAL ELECTRIC COMPANY, Schenectady, NY (US)

(21) Appl. No.: 11/617,353

(22) Filed: Dec. 28, 2006

(51) Int. Cl. B32B 15/16; B05D 1/12; B23K 1/20

(52) U.S. Cl. 428/554; 228/205; 427/180

(57) ABSTRACT

A method for manufacturing a brazed part is disclosed that includes coating a substrate surface to be joined by first cold spraying a braze filler metal powder upon the surface to clean the surface followed by further spray the powder to form a coating layer of a braze alloy upon the surface. The coated surface is assembled with another surface to be joined and brazed together to form the brazed part. The substrate and braze alloy may be nickel-based super alloy materials.

### FIELD OF THE INVENTION

The present invention is directed to a method that includes spraying a braze filler metal powder upon a substrate by high velocity cold spraying to first clean the substrate and then coat the surface with the braze filler metal powder. The coated and protected substrate is then brazed with another such substrate to form a part.

### BACKGROUND OF THE INVENTION

Nickel-based superalloys are widely used in brazed aerospace assemblies. Typically, these superalloys are brazed at temperatures at or above 1900° F. using nickel-based braze filler metals. Due to amounts of certain alloying elements, the faying surfaces of some of these superalloys need to be plated with a thin layer of nickel prior to brazing to protect the faying surfaces from exposure to the atmosphere during heat up to brazing temperatures. This exposure may produce an oxide layer that interferes with the subsequent wetting and flow of the molten braze filler metal.

A disadvantage of nickel plating is that the process adds time and steps to the brazing operation, and it uses chemicals that are environmentally unfriendly. Additionally, in most cases the entire part is nickel plated, since masking or selective plating is both difficult and expensive. Also, prior to this invention, it was only compositions of nickel plating containing phosphorous that were used as braze filler metals. Nickel braze filler metals containing phosphorous had limited application based on their lesser thermal and mechanical properties.

Cold gas dynamic spraying or kinetic metallization is a process that uses fine metal powders that are accelerated using a gaseous medium and impacted against a surface to form a coating of the metal powder upon the surface. The particles collide with the surface resulting in severe plastic deformation and bonding of these particles to the surface and to other particles. During the process, there is no melting of the particles. To date, cold gas dynamic spraying has been used to build up material deposits as coatings upon a substrate, but has not been used to apply braze filler material to substrates for surface cleaning and protection.

Therefore, what is needed is a process for preparing surfaces for brazing that does not suffer from the disadvantages of the existing surface preparation processes.

### SUMMARY OF THE INVENTION

Accordingly, it is an object of the present invention to use high velocity cold spraying to coat a braze alloy upon a substrate surface and then braze that surface to at least one other surface to form a brazed part.

One embodiment includes a method for manufacturing a brazed part comprising providing a substrate having a surface, directing a braze filler metal powder comprising a braze alloy by high velocity cold spraying in an inert atmosphere at the substrate surface to remove oxides from the substrate surface, continuing to direct the braze filler metal powder by high velocity cold spraying at the substrate surface to form a layer of the braze alloy upon the surface and form a coated substrate surface, contacting the coated substrate surface with at least one other substrate surface to form an assembly, and heating the assembly to braze the coated substrate with the at least one other substrate surface to form a brazed part.

Another embodiment includes a method of coating a braze alloy upon a substrate, comprising providing a substrate having a surface, directing a braze filler metal powder comprising a braze alloy by high velocity cold spraying in an inert atmosphere at the substrate surface to remove oxides from the substrate surface, and continuing to direct the braze filler metal powder by high velocity cold spraying at the substrate surface to form a braze alloy layer upon the substrate surface.

Still another embodiment includes a brazed part formed by the method comprising providing a substrate having a surface, directing a braze filler metal powder comprising a braze alloy by high velocity cold spraying in an inert atmosphere upon the substrate surface to remove oxides from the substrate surface, continuing to direct the braze filler metal powder by high velocity cold spraying at the substrate surface to form a layer of the braze alloy upon the surface and form a coated substrate surface, contacting the coated substrate surface with at least one other substrate surface to form an assembly, and heating the assembly to braze the coated substrate with the at least one other substrate surface to form a brazed part.

Still another embodiment includes a coated substrate formed by the method comprising providing a substrate having a surface, directing a braze filler metal powder comprising a braze alloy by high velocity cold spraying in an inert atmosphere at the substrate surface to remove oxides from the substrate surface, and continuing to direct the braze filler metal powder by high velocity cold spraying at the substrate surface to form a layer of the braze alloy upon the surface and form a coated substrate surface.

Other features and advantages of the present invention will be apparent from the following more detailed description of a preferred embodiment, taken in conjunction with the accompanying drawings, which illustrate by way of example, the principles of the invention.

### BRIEF DESCRIPTION OF THE DRAWINGS

FIG. 1 illustrates an apparatus for performing a method of applying braze filler metal powders to substrates for surface cleaning and protection.

### DETAILED DESCRIPTION OF THE INVENTION

Disclosed herein is a method for coating a substrate surface with a braze alloy by a high velocity cold spraying method. The coated substrate surface is then assembled with at least one other surface to form an assembled part that is heated to join the assembly to form a brazed part.

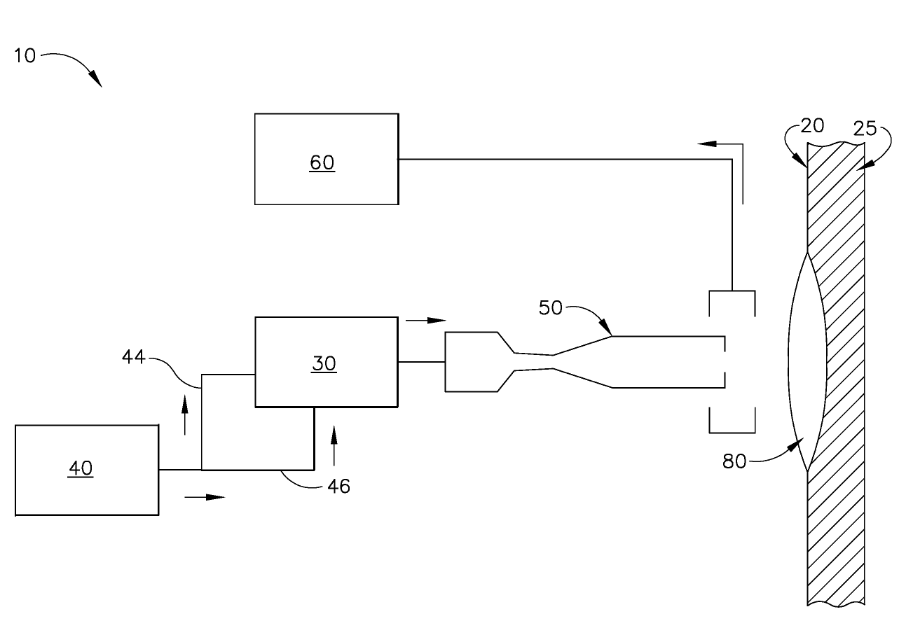

Referring now to FIG. 1, there is shown a system 10 for depositing a braze alloy onto a surface 20 of a substrate 25. The surface 20 may be an end of a component to be joined, such as a turbine component. The system 10 includes a powder feeder 30 that receives gas from a gas supply 40. The powder feeder 30 is supplied with a braze filler metal powder (not shown). The gas may be any inert gas, with argon and helium preferred. The gas is heated to about 1200° F. (649° C.) before entering the powder feeder 30. The gas may be heated at the gas supply 40 or while being supplied to the powder feeder 30.

The braze filler powder may be selected from, but not limited to nickel-based, cobalt-based, copper-based, gold-based, and silver-based braze alloys. The powder should be less than −325 mesh to reduce imperfections in the braze alloy coating. A nickel-based braze alloy may be used for brazing higher temperature materials such as nickel-based superalloys. For example, AMS4777 having a composition of Ni-7Cr-3Fe-3B-4.1Si may be used to braze substrates such as stainless steel, and nickel-based, cobalt-based and iron-based superalloys. Other high temperature braze alloys include, but are not limited to AMS4778 (Ni-2.9B-4.5Si), AMS4779 (Ni-1.9B-3.5Si) and AMS4782 (Ni-19Cr-10Si).

Cobalt-based braze alloys, typically used on nickel-based, cobalt-based, and iron-based superalloys, include AMS4783 (Co-17Ni-19Cr-0.8B-8Si-4W). Gold-based braze alloys, typically used on assemblies requiring higher ductility joints, include AMS4784 (50Au-25Pc-25Ni), AMS4786 (70Au-8Pd-22Ni), and AMS4787 (82Au-18Ni). Copper-based braze alloys, typically used on assemblies exposed to less hostile environments, include, but are not limited to, AMS4764 (52.5Cu-38Mn-9.5Ni), BCu-1 (99.9% pure Cu), BCuP-1 (Cu-5P), and BCuP-3 (Cu-5Ag-7P).

The substrate 25 to be brazed may be selected from nickel-base, cobalt-base and iron-base superalloys that require a coating of a braze alloy prior to brazing. A typical nickel-based superalloy is Inconel 718.

The gas is supplied to the feeder box 30 by two lines. A first line 44 by-passes the powder in the powder feeder 30 and is used to heat nozzle 50 to a temperature of about 1200° F. (649° C.). After the gas heats the nozzle 50 to about 1200° F. (649° C.), the gas is then supplied by a second line 46 to the powder feeder 30 at a pressure of between about 250 psi and 400 psi to suspend and direct the powder to nozzle 50. The powder is directed from the nozzle 50 at a nozzle pressure of between about 40 psi and about 70 psi at subsonic velocity towards a substrate 60 having a surface 65. The powder temperature leaving the nozzle 50 should be between about 350° F. (177° C.) and about 650° F. (343° C.). Nickel-based, cobalt-based, gold-based and silver-based braze metal powders are preferably heated to between about 500° F. (260° C.) and about 650° F. (343° C.). The copper-based braze alloys are preferably heated to a temperature range of between about 350° F. (177° C.) and 500° F. (260° C.).

The braze filler metal powder that first impacts the surface 65 acts as a blasting media and cleans the surface by removing a thin layer of surface material. The layer of surface material removed is more than zero and less than about 1 micron, but is sufficient to substantially remove any surface oxide.

After the braze filler metal powder removes the oxide layer, the powder begins to adhere and bond to the surface 65. The powder is directed towards the surface 65 until a layer of braze alloy 80 is formed. The powder that does not adhere to the surface 20 is removed from the area by a suction system 60. The powder that is removed and collected by the suction system 60 may be recycled to be used as a source of braze filler metal powder. A braze alloy layer of between about 0.001 inch and about 0.004 inch is formed prior to subsequent vacuum brazing operations.

For example, a braze alloy layer was formed using a nickel-based braze alloy metal powder of the composition Ni-7Cr-3Fe-3B-4.1Si at a spray temperature of about 600° F. (315° C.). The formed layer was about 0.003 inch thick. The formed layer had substantially no oxides between the braze alloy layer and the substrate. The coated substrate was then successfully vacuum brazed during subsequent operations.

The coated substrate surface is brought into contact with at least one other substrate surface to form an assembly. The at least one other substrate surface must be free of oxides to ensure a strong braze joint between the surfaces. Preferably, the at least one other substrate surface has been coated in a similar manner with the same braze alloy as the coated substrate surface.

The assembly is heated to the brazing temperature of the braze alloy and cooled to form the brazed part. For nickel-based superalloy substrates brazed by nickel-based braze alloys, a brazing temperature range from about 1800° F. (982° C.) to about 2250° F. (1232° C.) may be used.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for manufacturing a brazed part, comprising:
providing a substrate having a surface;
directing a braze filler metal powder comprising a braze alloy by high velocity cold spraying in an inert atmosphere at the substrate surface to remove oxides from the substrate surface;
continuing to direct the braze filler metal powder by high velocity cold spraying at the substrate surface to form a layer of the braze alloy upon the surface and form a coated substrate surface;
contacting the coated substrate surface with at least one other substrate surface to form an assembly; and
heating the assembly to braze the coated substrate with the at least one other substrate surface to form a brazed part.

2. The method of claim 1, wherein the substrate is selected from a group comprising nickel-based, cobalt-based, and iron-based superalloys.

3. The method of claim 1, wherein the braze filler metal powder is selected from a group comprising nickel-based, cobalt-based, copper-based and gold-based braze alloys.

4. The method of claim 1, wherein the braze filler metal powder is selected from a group comprising nickel-based, cobalt-based, and gold-based braze alloys and is at a temperature of between about 500° F. and 650° F. when directed at the substrate surface.

5. The method of claim 1, wherein the braze filler metal powder comprises a copper-based braze alloy at a temperature of between about 350° F. and 500° F. when directed at the substrate surface.

6. The method of claim 2, wherein the substrate is a nickel-based superalloy.

7. The method of claim 6, wherein the braze filler metal powder is nickel-based braze alloy.

8. The method of claim 1, wherein more than zero and less than about 0.0001 inch of the substrate surface is removed by the directing of the braze alloy powder at the substrate surface.

9. The method of claim 1, wherein the braze filler metal powder is continued to be applied to the substrate surface until a layer of braze alloy between about 0.001 inch and about 0.004 inch is coated upon the substrate surface.

10. A method of coating a braze alloy upon a substrate, comprising:
providing a substrate having a surface;
directing a braze filler metal powder comprising a braze alloy by high velocity cold spraying in an inert atmosphere at the substrate surface to remove oxides from the substrate surface; and
continuing to direct the braze filler metal powder by high velocity cold spraying at the substrate surface to form a layer of the braze alloy upon the surface and form a coated substrate surface;

11. The method of claim 10, wherein the substrate is selected from a group comprising nickel-based, cobalt-based, and iron-based superalloys.

12. The method of claim 10, wherein the braze filler metal powder is selected from a group comprising nickel-based, cobalt-based, copper-based and gold-based braze alloy powders.

13. The method of claim 10, wherein the braze filler metal powder is at a temperature of between about 350° F. and 650° F. when directed at the substrate surface.

14. The method of claim 11, wherein the braze filler metal powder is nickel-based braze alloy.

15. The method of claim 10, wherein more than zero and less than about 0.0001 inch of the substrate surface is removed by the directing of the braze alloy powder at the substrate surface.

16. The method of claim 10, wherein the braze alloy layer is between about 0.001 inch and about 0.004 inch thick.

17. A brazed part formed by the method comprising:
providing a substrate having a surface;
directing a braze filler metal powder comprising a braze alloy by high velocity cold spraying in an inert atmosphere at the substrate surface to remove oxides from the substrate surface;
continuing to direct the braze filler metal powder by high velocity cold spraying at the substrate surface to form a layer of the braze alloy upon the surface and form a coated substrate surface;
contacting the coated substrate surface with at least one other substrate surface to form an assembly; and
heating the assembly to braze the coated substrate with the at least one other substrate surface to form a brazed part.

18. The brazed part of claim 17, wherein the brazed part further comprises substantially no oxides between the braze alloy layer and the substrate.

19. The brazed part of claim 17, wherein the substrate comprises a nickel-based superalloy.

20. The brazed part of claim 17, wherein the braze filler metal powder is selected from a group comprising nickel-based, cobalt-based, copper-based and gold-based braze alloys.

21. The brazed part of claim 17, wherein the braze filler metal powder is at a temperature of between about 350° F. and 650° F. when directed at the substrate surface.
